(19) United States
(12) Patent Application Publication
(10) Pub. No.: US 2012/0154947 A1
(43) Pub. Date: Jun. 21, 2012

(54) METHOD OF CONTROLLING DEFECTS AND APPARATUSES USING THE SAME

(75) Inventors: Joo Won CHO, Gwacheon-si (KR); Seung Youl Jeong, Hwaseong-si (KR)

(73) Assignee: Samsung Electronics Co., Ltd., Suwon-si (KR)

(21) Appl. No.: 13/325,280

(22) Filed: Dec. 14, 2011

(30) Foreign Application Priority Data
Dec. 15, 2010 (KR) 10-2010-0128463

(51) Int. Cl. G11B 27/36

(52) U.S. Cl. 360/53; G9B/27.052

(57) ABSTRACT

The method of controlling a defect of a hard disk drive that includes analyzing a defect type by using indexes of error corrected symbols after performing error correction with respect to each of a plurality of symbols and setting a sector as unusable when the sector includes a defect that is determined to be a defect having a defect type that is a hard defect.

### CROSS-REFERENCE TO RELATED APPLICATIONS

This application claims priority under 35 U.S.C. §119(a) from Korean Patent Application No. 10-2010-0128463 filed on Dec. 15, 2010, the disclosure of which is hereby incorporated by reference in its entirety.

### BACKGROUND

1. Field

Example embodiments relates to a method of managing a defect, and more particularly, to a method of efficiently controlling a defect by analyzing a defect type and apparatuses performing the method.

2. Description of the Related Art

A defect may be generated in a magnetic storage media such as a hard disk drive as a result of changes in a manufacturing process. When the defect is not managed properly, the size of the defect may increase, thereby increasing the possibility of an increase in the number of error bits.

### SUMMARY

The present inventive concept provides a method of effectively controlling a defect by analyzing a defect type, a hard disk drive enabling to perform the method, and a computer system including the hard disk drive.

Additional aspects and advantages of the present general inventive concept will be set forth in part in the description which follows and, in part, will be obvious from the description, or may be learned by practice of the general inventive concept.

According to an exemplary embodiment of the present inventive concept, there is provided a method of controlling a defect in a hard disk drive including analyzing a defect type by using indexes of error corrected symbols after performing error correction with respect to a plurality of symbols and setting a sector including a hard defect as unusable when the analysis determines that the defect type of the defect included in the sector is a hard defect.

The analyzing the defect type includes arranging the indexes of the error corrected symbols; computing values of moving summation with respect to selected indexes among arranged indexes of the error corrected symbols, comparing each value of the values of the moving summations with a reference value, and determining that the defect type of the defect included in the sector is the hard defect when at least one of the values of the moving summations is greater than the reference value.

The method may further include setting a sector adjacent to the sector having the hard defect as to be unusable when the method is performed in a burn-in test.

The method may further include reassigning the sector having the hard defect to an accessible sector when the method is performed in a retry operation.

The method may further include reassigning a sector adjacent to the sector including the hard defect to another accessible sector.

According to another exemplary embodiment of the present inventive concept, there is provided a hard disk drive including a disk having a plurality of sectors, a head to access the disk, and a main control unit, the main control unit performing error correction with respect to each of a plurality of symbols based on a signal output from the head, analyzing a defect type of a defect included in a sector of the plurality of sectors by using indexes of error corrected symbols, and setting the sector of the plurality of sectors that includes the defect as to be unusable when the defect type of the defect included in the sector of the plurality of sectors is determined to be a hard defect.

The main control unit may arrange the indexes of the error corrected symbols, compute values of moving summations with respect to selected indexes among the arranged indexes of error corrected symbols, compare each of the values of the moving summations with a reference value, and determine that the defect type of the defect included in the sector of the plurality of sectors is the hard defect when at least one of the moving summation values is greater then the reference value.

The main control unit may set a sector which is adjacent to the sector having the hard defect as to be unusable during a burn-in test.

The main control unit may reassign the sector including the hard defect to an accessible sector during a retry process.

The main control unit may reassign a sector which is adjacent to the sector including the hard defect to another accessible sector.

According to another exemplary embodiment of the present inventive concept, there is provided a computer system including the hard disk drive and a host to control operation of the hard disk drive.

According to another exemplary embodiment of the present inventive concept, there is provided a method of determining a defect of a hard disk drive having a plurality of sectors that includes: arranging an index of a plurality of symbols, wherein each of the plurality of symbols indicates whether the plurality of symbols have been subjected to error correction; selecting a first subset of at least two sequential symbols of the plurality of symbols contained within the index of the plurality of symbols; determining a number of the at least two sequential symbols of the selected first subset that have been subjected to error correction; comparing a reference value with the number of the at least two sequential symbols of the selected first subset that have been subjected to error correction; and setting a sector of the plurality of sectors as unusable when the number of the at least two sequential symbols of the selected first subset that have been subjected to error correction is greater than the reference value.

The method of determining a defect of a hard disk drive may further include: selecting a second subset of at least two sequential symbols of the plurality of symbols contained within the index of the plurality of symbols, the second subset including: (i) the plurality of symbols selected for the first subset except an earliest symbol in a sequence defined by the at least two sequential symbols selected for the first subset, and (ii) a next sequential symbol of the plurality of symbols with respect to the at least two sequential symbols selected for the first subset; determining a number of the at least two sequential symbols of the selected second subset that have been subjected to error correction; comparing the reference value with the number of the at least two sequential symbols of the selected second subset that have been subjected to error correction; and setting the sector of the plurality of sectors as unusable when the number of the at least two sequential symbols of the selected second subset that have been subjected to error correction is greater than the reference value.

The method of determining a defect of a hard disk drive may further include that when the method is performed in a burn-in test, setting at least one adjacent sector of the plurality of sectors with respect to the sector of the plurality of sectors as unusable.

The method of determining a defect of a hard disk drive may further include that when the method is performed in a retry operation, reassigning the sector of the plurality of sectors to an accessible sector of the plurality of sectors.

The method of determining a defect of a hard disk drive may further include reassigning at least one adjacent sector of the plurality of sectors with respect to the sector of the plurality of sectors to another accessible sector of the plurality of sectors.

Further, each of the plurality of symbols may be formed of at least two bits.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 is a block diagram of an hard disk drive (HDD) according to an exemplary embodiment of the present inventive concept;

FIG. 2 is a diagram of any one of a plurality of disks illustrated in FIG. 1;

FIG. 3 is a diagram illustrating moving summations according to an exemplary embodiment of the present inventive concept;

FIG. 4 is a graph of illustrating results of the moving summations according to an exemplary embodiment of the present inventive concept;

FIG. 5 is a flowchart illustrating a method of controlling a defect according to an exemplary embodiment of the present inventive concept; and

FIG. 6 is a block diagram of a computer system including the HDD according to an exemplary embodiment of the present inventive concept.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments may be embodied in many different forms and should not be construed as limited to the embodiments set forth herein. In the drawings, the size and relative sizes of layers and regions may be exaggerated for clarity and are not necessarily to scale.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

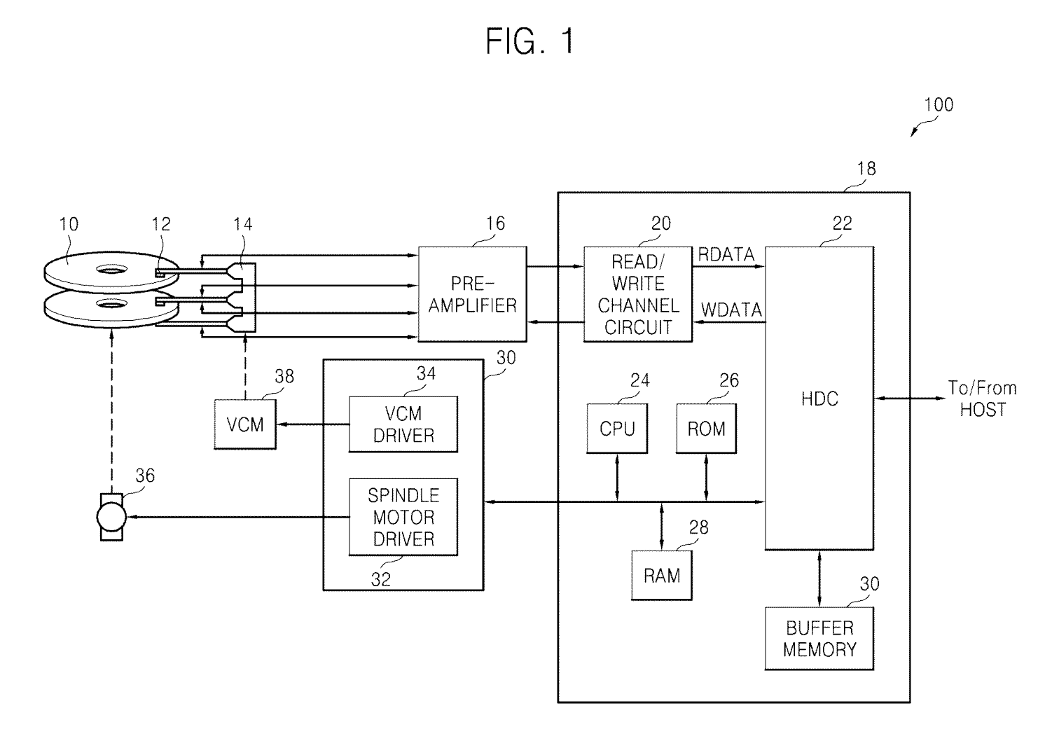

FIG. 1 is a block diagram of a hard disk drive (HDD) 100 according to an exemplary embodiment of the present inventive concept. Referring to FIG. 1, the HDD 100 which may be used as a data storage device includes a plurality of hard disks 10, a plurality of heads 12, a head assembly 14, a pre-amplifier 16, a main control unit (MCU) 18, a motor control unit or servo control unit 30, a spindle motor 36, and a voice coil motor (VCM) 38.

Each of the hard disks 10 may store data output from a host and be rotated by the spindle motor 36. Each of the heads 12 is located over a corresponding one of the hard disks 10 and performs read and/or write operations. Each of the heads 12 is installed on a corresponding support arm coupled to the VCM 38, and extends from the head assembly 14 toward the hard disks 10.

When data stored in the hard disks 10 that is a magnetic storage medium is read, the pre-amplifier 16 amplifies an analog read signal output from any one of the heads 12 and outputs an amplified analog read signal to a read/write channel circuit 20. When data is written to the hard disks 10, the pre-amplifier 16 transmits a write signal output from the read/write channel circuit 20, for example, a write current, to any one of the heads 12. Thus, the any one of the heads 12 may write the write signal to any one of the disks 10.

The read/write channel circuit 20 converts the analog read signal amplified by the pre-amplifier 16 to read data RDATA and outputs the RDATA to a hard disk controller (HDC) 22. Also, the read/write channel circuit 20 converts write data WDATA output from the hard disk controller (HDC) 22 to a write signal and outputs the write signal to the pre-amplifier 16.

When data is written to the hard disks 10, the HDC 22 outputs the write data WDATA output from a host (not shown) to the read/write channel circuit 20 under the control of a central processing unit (CPU) 24. Accordingly, the write data WDATA output from the host may be written to any one of the hard disks 10 via the read/write channel circuit 20, the pre-amplifier 16, and a corresponding one of the heads 12.

When data is read from the hard disks 10, the HDC 22 may receive decoded read data RDATA decoded by the read/write channel circuit 20, perform error correction with respect to the received read data RDATA and transmit the error corrected data RDATA to the host via an interface (not shown), under the control of the CPU 24.

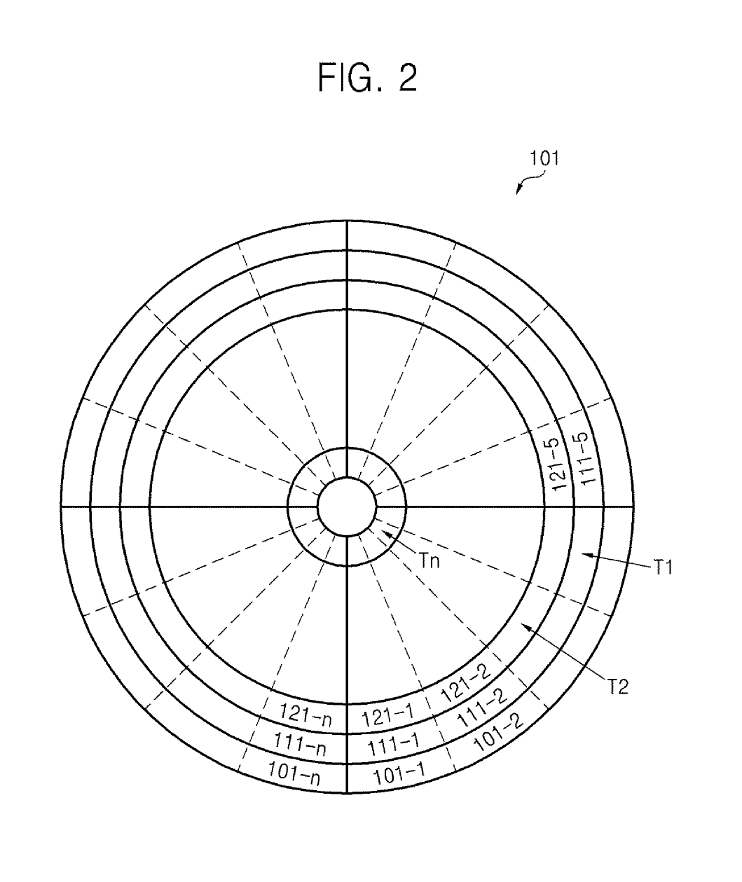

FIG. 2 is a diagram illustrating any one of a plurality of hard disks illustrated in FIG. 1. Referring to FIGS. 1 and 2, the hard disk 101 of the plurality of disks 10 includes a plurality of tracks T1˜Tn. Also, each of the disks (e.g., hard disk 101) includes a plurality of sectors 101-1˜101-n, 111-1˜111-n, and 121-1˜121-n. In each of the sectors 101-1˜101-n, defects may be generated as a result of changes in the manufacture process and/or environment. The resulting defect may generate an error during a read operation of the hard disk 101. Thus, the HDC 22 corrects errors by using an error correction code (ECC) that is composed of extra bits. For example, the ECC may be Low-Density Parity-Check (LDPC) code or Reed-Solomon (RS) code.

The capability of the error correction is determined by the ECC, that is, the error correction capabilities are determined by the number of extra bits. For example, when the number of the extra bits increases, the number of error bits or inverted bits increases.

The capability of the error correction is estimated by the number of symbols. A symbol is formed of 2 or more bits and may be formed of 10 bits, for example. Alternatively, a symbol may be formed of, for example, 8 bits or 12 bits in some embodiments.

The HDC 22 performs error correction with respect to each symbol, and then, analyzes a defect type by using each index of the corrected symbols. The analyzing operation will be described later in greater detail.

Each of the indexes of symbols denotes whether each symbol has been corrected or not. For example, when an index is bit ‘1’, it denotes the symbol has been corrected, and when the index is bit ‘0’, it denotes the symbol was not corrected.

The defect type may include a soft defect and a hard defect. A soft defect denotes that the size of a defect is small, and the error can be restored by using the ECC. A hard defect denotes that the size of defect is larger. With hard defects, the error may not be able to be restored by using the ECC. However, in the case where the error resulting from a hard defect has been restored by using the ECC, the sector with a hard defect may nonetheless become a failure over time.

In the case where the hard defect exists on a first sector 111-1, the hard defect may grow on adjacent sectors over time, for example, 101-2, 111-2, 121-2, 101-1, 121-1, 101-n, 111-n or 121-n. Thus, the HDC 22 is analyzes a defect type after the error correction, and when the defect type is a hard defect, the HDC 22 manages the hard defect efficiently.

To control hard defects, the HDC 22 may operate in, for example, a burn-test and a retry process and the method of controlling a hard defect may be different between when the HDC 22 operates in the burn-in test and when the HDC 22 operates in the retry process. The burn-in test is a read/write test to detect the defect before shipment of a product to a user. The retry process is a process performed in a read error situation after shipment to the user, which is repeatedly performed until the read error is not generated or until the number of read retries reaches a predetermined number.

For example, when the HDC 22 operates in a burn-in test, the HDC 22 generates flag information so that the sector including the hard defect (e.g., first sector 111-1) may undergo flagging. The HDC 22 sets the first sector 111-1 as to be unusable by using the flag information. Also, the HDC 22 sets at least one adjacent sector, for example, 101-2, 111-2, 121-2, 101-1, 121-1, 101-n, 111-n, or 121-n as to be unusable.

When the HDC 22 operates in a retry process, the HDC 22 generates flag information so that a first sector 111-1 including the hard defect may undergo flagging. The HDC 22 sets the first sector 111-1 as to be unusable by using the flag information and reassigns the first sector 111-1 to an accessible sector, for example, 111-5. Also, the HDC 22 may reassign at least one adjacent sector, for example, 101-2, 111-2, 121-2, 101-1, 121-1, 101-n, 111-n, or 121-n to another accessible sector, for example, 121-5.

Referring to FIG. 1, the CPU 24 may read a control code or boot code stored in a read only memory (ROM) 26 and store the control code or the boot code in a random access memory (RAM) 28. The CPU 24 may generally control the operation of the HDD 100 or the HDC 22 based on the control code or boot code stored in the RAM 28. Thus, the CPU 24 may control the read and/or write operations of the HDD 100, and also control the defect control operation according to an exemplary embodiment of the present inventive concept. Although FIG. 1 illustrates ROM and RAM as a single memory device, the ROM and RAM may be separate memory devices which are physically discrete from one another.

The CPU 24 may receive a read or write command output from the host via the interface connected to a bus (not shown). To control track seek or track following according to a received command, the CPU 24 may control the operation of a servo controller (not shown) to control a spindle motor driver 32 and a VCM driver 34.

The spindle motor driver 32 controls the operation of the spindle motor 38 to control rotation of each of the hard disks 10, in response to a control signal output from the servo controller of the HDC 22. The VCM driver 34 generates a driving current to drive the VCM 38 and outputs the driving current to a voice coil of the VCM 38, in response to a control signal to control the position of each of the heads 12 output from the servo controller.

Thus, the VCM 38 moves one of the heads 12 to a track formed on a corresponding one of the disks 10 where data is written, according to the direction and level of the driving current output from the VCM driver 34. The head 12 moved by the VCM 38 outputs position information written to the hard disks 10 to the pre-amplifier 16 according to a control signal output from the read/write channel circuit 20 or under the control of the HDC 22.

When the head 12 is moved to a target track of the hard disks 10 to read, a disk formatter (not shown) of the HDC 22 outputs a servo gate signal to the read/write channel circuit 20. The read/write channel circuit 20 reads a servo pattern written on the hard disk 10 in response to the servo gate signal.

A buffer memory 28 may temporarily store data exchanged between the HDD 100 and the host. In some embodiments, the buffer memory 28 may be embodied outside the main control unit 18.

According to an exemplary embodiment, the main control unit 18 including the read/write channel circuit 20, the HDC 22, the CPU 24, the ROM 26, and the RAM 28 may be embodied in a single chip, for example, a system on chip (SoC). Also, the motor control block 30 including the spindle motor driver 32 and the VCM driver 34 may be embodied in a single chip, for example, a SoC.

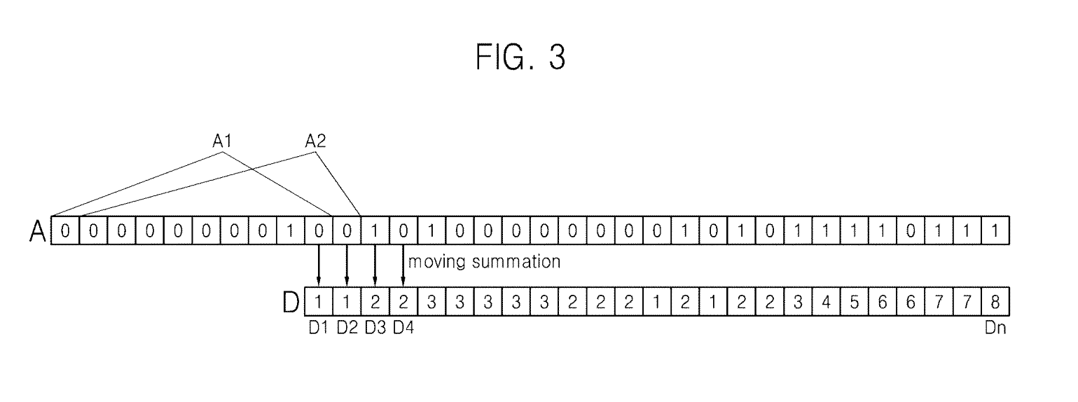

FIG. 3 is a diagram illustrating moving summations according to an exemplary embodiment of the present inventive concept. Referring to FIGS. 1 to 3, the analysis operation of the HDC 22 will be described in detail below. The HDC 22 performs error correction with respect to each symbol, and then arranges indexes A of each of the corrected symbols. Each of bits shown in FIG. 3 denotes the indexes. The bit ‘1’ denotes that the symbol has been corrected and the bit ‘0’ denotes that the symbol has not been corrected.

The HDC 22 computes moving summation values D of the selected indexes A1 among the indexes A. For exemplary purposes, the number of bits of the selected indexes is, for example, 9. The moving summation is the adding up of the bits within the selected indexes A1 together (i.e., bits 1-9) to obtain a first moving summation D1. To obtain the next moving summation D2, HDC 22 adds the sequentially selected indexes A2 (i.e., bits 2-10) as continuously increasing by one bit. For instance, as shown in FIG. 3, each bit (i.e., bits 1-9) of the selected indexes A1 is ‘0’, ‘0’, ‘0’, ‘0’, ‘0’, ‘0’, ‘0’, ‘0’, and ‘1’ in order, which results in the value of the moving summation D1 being ‘1’. When the selected indexes A1 moves to A2, each bit of the selected indexes A2 (i.e., bits 2-10) is ‘0’, ‘0’, ‘0’, ‘0’, ‘0’, ‘0’, ‘0’, ‘1’, and ‘0’. Thus, the value of the moving summation D2 is ‘1’. With this mechanism, the HDC 22 may compute values of each of the moving summations D3, D4, . . . , or Dn. Although the present inventive concept takes the number of bits of the selected indexes to be 9, the number is not limited to this value.

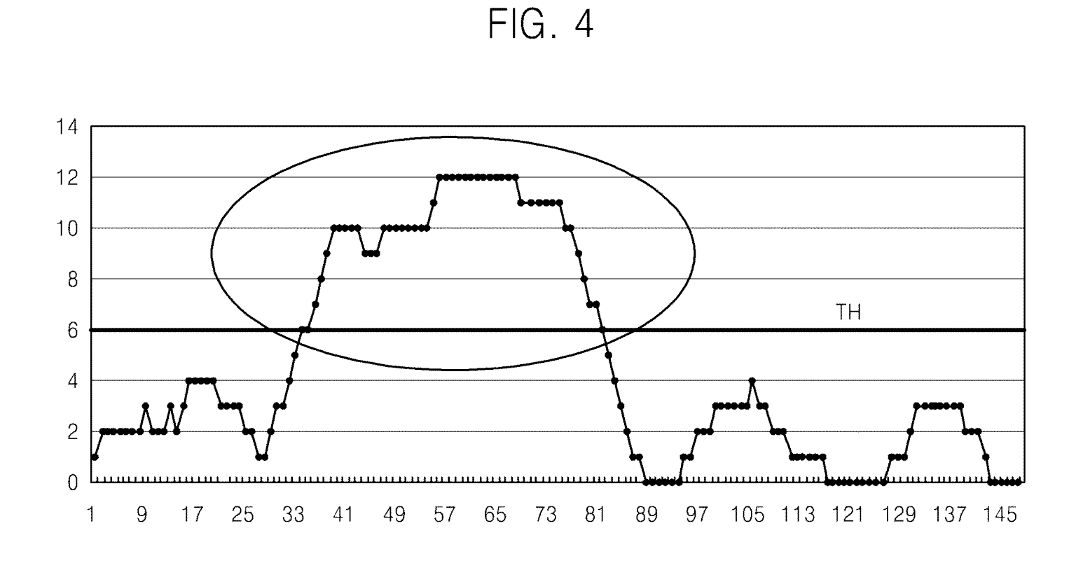

FIG. 4 is a graph of illustrating results of the moving summations according to an exemplary embodiment of the present inventive concept. Referring to FIG. 4, an X-axis denotes the position of the corrected symbols, and a Y-axis denotes the value of the moving summation. Referring to FIGS. 1 through 4, the HDC 22 compares each of the values of the moving summations D1˜Dn with a reference value TH.

The HDC 22 determines a defect type as a hard defect when at least any one of the values of the moving summations D1˜Dn is greater than the reference value TH. For instance, the index position 57 of the corrected symbols has the moving summation value 12, which is greater than the reference value TH, thus, the HDC 22 determines the defect type as the hard defect. Accordingly, the HDC 22 analyzes the defect type resulting in controlling the defect efficiently based on the analysis result.

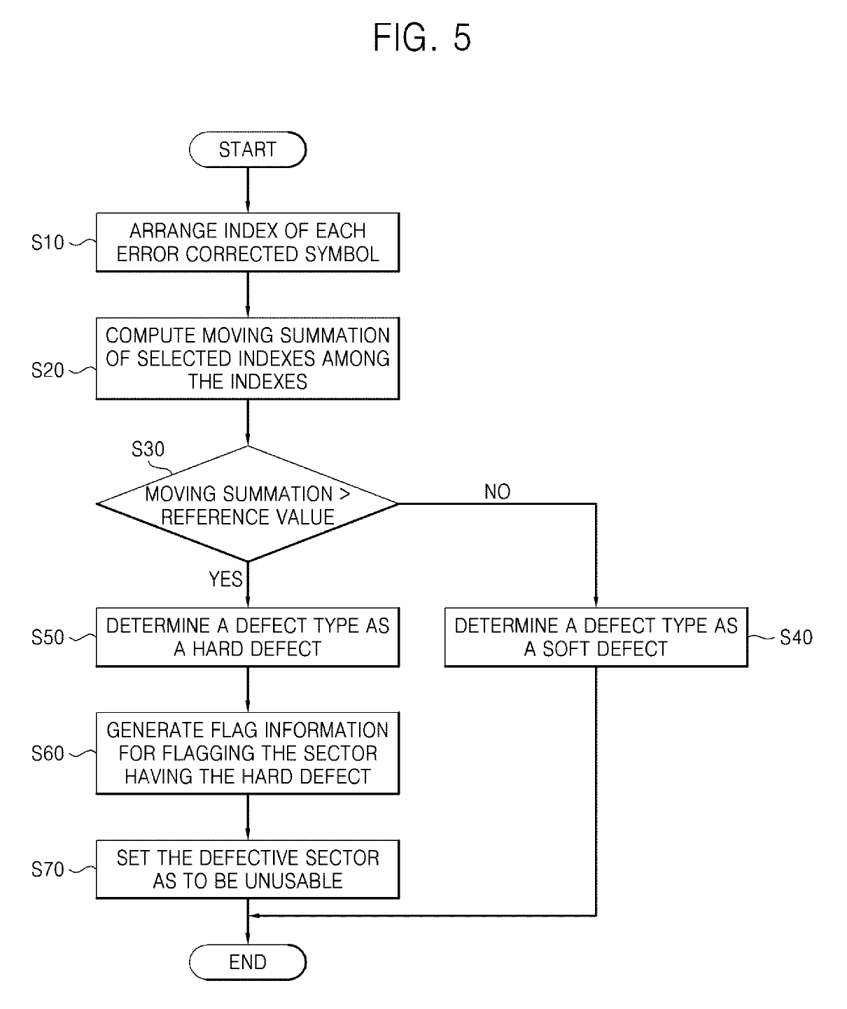

FIG. 5 is a flowchart illustrating a method of controlling a defect according to exemplary embodiment of the present inventive concept. Referring to FIGS. 1 through 5, the HDC 22 arranges indexes A of each corrected symbol after performing error correction with respect to each symbol (S10).

The HDC 22 computes values of the moving summations with respect to the selected indexes A1 among the indexes A (S20). And, the HDC 22 compares each value of the moving summations D1˜Dn with the reference value TH (S30). When each of the moving summations D1˜Dn is smaller than the reference value TH, the HDC 22 determines the defect type as a soft defect (S40). When at least any one of the value of the moving summations D1˜Dn is greater than the reference value TH, the HDC 22 determines the defect type as a hard defect (S50).

The HDC 22 generates flag information so that the sector 111-1 including the hard defect may undergo flagging (S60). The HDC 22 sets the sector 111-1 as to be unusable by using the flag information (S70). For instance, when the HDC 22 operates in a burn-in test, the HDC 22 sets at least one sector, for example, 101-2, 111-2, 121-2, 101-1, 121-1, 101-n, 111-n, or 121-n adjacent to the sector 111-1 as to be unusable.

Also, when the HDC 22 operates in a retry process, the HDC sets the sector 111-1 as to be unusable and reassigns the sector 111-1 to an accessible sector, for example, 111-5. The HDC 22 may reassign at least one adjacent sector, for example, 101-2, 111-2, 121-2, 101-1, 121-1, 101-n, 111-n, or 121-1 to another accessible sector, for example, 121-5.

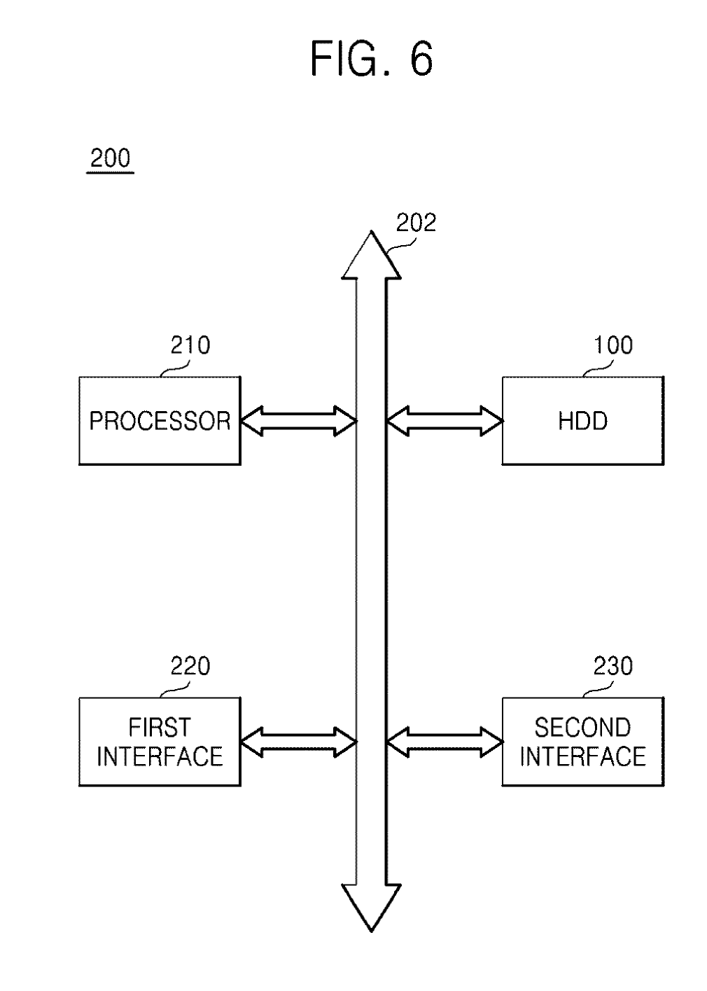

FIG. 6 is a block diagram of a computer system including the HDD according to an exemplary embodiment of the present inventive concept. Referring to FIG. 6, the computer system 200 includes all of the data storage devices in which a magnetic recording medium may be used as a data storage device, such as personal computer (PC), laptop computer, net-book, portable computer, handheld communication device, digital TV, or home automation device.

The computer system 200 includes the HDD 100 and a processor 210 which connect with one another via a system bus 202. The processor 210 acts as host and may control general operation of the HDD 100, for example, a read operation or a write operation.

The HDD 100, as described referring to FIGS. 1 through 5, performs error correction with respect to each symbol based on the signal output from the head 12, analyzes the defect type by using each index of the corrected symbols, and when the defect type is a hard defect, the HDD sets the sector including the hard defect as to be unusable.

The computer system 200 may further include a first interface 220. The first interface 220 may be embodied into input/output interface. For example, the first interface 220 may be an output device such as monitor or printer, or an input device such as touch screen, mouse, or keyboard.

The computer system 200 may further include a second interface 230. The second interface may be wireless communication interface enabling to perform wireless communication with outside computer system. The second interface 230 may transmit the stored data into outside computer system by wireless under the control of the processor 210, or store the data received from the outside computer system to the HDD 100. In some embodiments, in case that the computer system 200 is embodied into a hybrid HDD, the computer system 200 may further include a non-volatile memory device. The processor 210 may store data to the HDD 100 or the non-volatile memory device according to a data storage policy.

As described above, the method of controlling the defect according to the present inventive concept and apparatuses performing the method may control the defect effectively by analyzing the defect type.

Although a few embodiments of the present general inventive concept have been shown and described, it would be appreciated by those skilled in the art that changes may be made in these embodiments without departing from the principles and spirit of the inventive concept, the scope of which is defined in the claims and their equivalents.

1. A method of controlling a defect of a hard disk drive, the method comprising:
analyzing a defect type by using indexes of error corrected symbols after performing error correction with respect to a plurality of symbols; and
setting a sector including a defect as unusable when the analysis determines that the defect type of the defect included in the sector is a hard defect.

2. The method of claim 1, wherein the analyzing the defect type comprises:
arranging the indexes of the error corrected symbols;
computing values of moving summations with respect to selected indexes among the arranged indexes of the error corrected symbols;
comparing each of the values of the moving summations with a reference value; and
determining that the defect type of the defect included in the sector is the hard defect when at least one of the values of the moving summations is greater than the reference value.

3. The method of claim 1 further comprising, when the method is performed in a burn-in test, setting a sector adjacent to the sector including the hard defect as unusable.

4. The method of claim 1 further comprising, when the method is performed in a retry operation, reassigning the sector including the hard defect to an accessible sector.

5. The method of claim 4 further comprising reassigning a sector adjacent to the sector including the hard defect to another accessible sector.

6. A hard disk drive, comprising:
a hard disk including a plurality of sectors;
a head to access the disk; and
a main control unit performing error correction with regards to a plurality of symbols based on a signal output from the head, analyzing a defect type of a defect included in a sector of the plurality of sectors by using indexes of error corrected symbols, and setting the sector of the plurality of sectors that includes the defect as unusable when the defect type of the defect included in the sector of the plurality of sectors is determined to be a hard defect.

7. The hard disk drive of claim 6, wherein the main control unit arranges the indexes of the error corrected symbols, computes values of moving summations with respect to selected indexes among the arranged indexes of error corrected symbols, compares each of the values of the moving summations with a reference value, determines that the defect type of the defect included in the sector of the plurality of sectors is the hard defect when at least one of the values of the moving summations is greater than the reference value.

8. The hard disk drive of claim 6, wherein, during a burn-in test, the main control unit sets a sector which is adjacent to the sector of the plurality of sectors that includes the defect determined to be the hard defect as unusable.

9. The hard disk drive of claim 6, wherein, during a retry process, the main control unit reassigns the sector of the plurality of sectors that includes the defect determined to be the hard defect to an accessible sector.

10. The hard disk drive of claim 9, wherein the main control unit reassigns at least one adjacent sector of the plurality of sectors with respect to the sector of the plurality of sectors including the defect determined to be the hard defect to another accessible sector.

11. A computer system comprising:
a hard disk drive; and
a host to control an operation of the hard disk drive, wherein the hard disk drive includes:
a hard disk including a plurality of sectors;
a head to access the disk; and
a main control unit performing error correction with respect to a plurality of symbols based on a signal output from the head, analyzing a defect type of a defect included in a sector of the plurality of sectors by using indexes of error corrected symbols, and setting the sector of the plurality of sectors that includes the defect as unusable when the defect type of the defect included in the sector of the plurality of sectors is a hard defect.

12. The computer system of claim 11, wherein the main control unit arranges the indexes of the error corrected symbols, computes values of moving summations of selected indexes among the arranged indexes, compares each of the values of the moving summations with a reference value, and determines that the defect type of the defect included in the sector of the plurality of sectors is the hard defect when at least one of the values of the moving summations is greater than the reference value.

13. The computer system of claim 11, wherein, during a burn-in test, the main control unit sets a sector which is adjacent to the sector of the plurality of sectors that includes the defect determined to be the hard defect as unusable.

14. The computer system of claim 11, wherein, during a retry process, the main control unit reassigns the sector of the plurality of sectors that includes the defect determined to be the hard defect to an accessible sector.

15. The computer system of claim 14, wherein the main control unit reassigns at least one adjacent sector of the plurality of adjacent sectors with respect to the sector of the plurality of sectors including the defect determined to be the hard defect to another accessible sector.

16-21. (canceled)
